(19) United States
(12) Patent Application Publication
(10) Pub. No.: US 2005/0241657 A1
(43) Pub. Date: Nov. 3, 2005

(54) Removal of nitrogen containing compounds from tobacco

(75) Inventors: John-Paul Mua, Macon, GA (US); Brad L. Hayes, Macon, GA (US)

Correspondence Address: JOHN F. SALAZAR;MIDDLETON & REUTLINGER, 2500 BROWN & WILLIAMSON TOWER, LOUISVILLE, KY, 40202, US

(73) Assignee: Brown & Williamson Tabacco Corporation, Louisville, KY (US)

(21) Appl. No.: 10/835,379

(22) Filed: Apr. 29, 2004

(51) Int. Cl. B01J 20/02; A24B 15/24

(52) U.S. Cl. 131/309; 502/401; 131/300

(57) ABSTRACT

The present invention provides for a process for removing nitrogen containing compounds from tobacco with minimum removal of desired compounds. The process includes the steps of mixing a tobacco containing material with an aqueous solvent to form an extract; the extract is then separated from the tobacco containing material and contacted with an adsorbent material. The adsorbent material is selected from the group consisting of a bentonite and a charcoal material, β-cyclodextrin, cellulose acetate and combinations thereof. The extract is then added back to the tobacco containing material that may or may not have been processed.

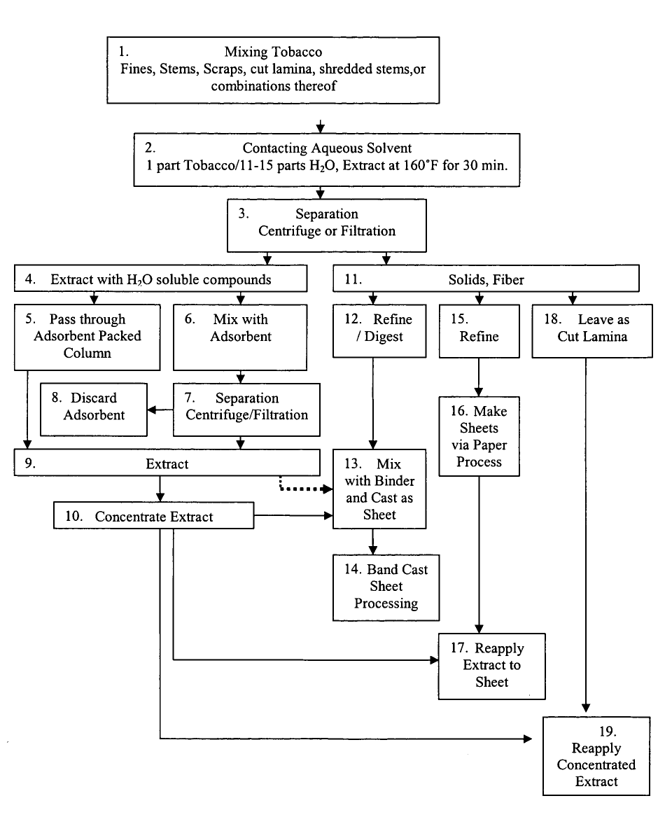

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF INVENTION

The present invention relates to a process for removal of nitrogen containing compounds from tobacco with minimum removal of desired compounds such as alkaloids, phosphates and other compounds that contribute to the flavor of the smoking article or decrease formation of undesired compounds in the smoke.

### BRIEF SUMMARY OF THE INVENTION

Selectivity in tobacco component removal is vital for production of cigarettes with good smoke quality. The present invention involves selective component removal from tobacco by extracting components from tobacco by liquid extraction and treating the tobacco extract with adsorbents and then adding back the treated extract to the tobacco. The tobacco may be in the form of washed lamina, fiber, or fiber formed sheets. The adsorbents can be in the form of organic or inorganic solids such as for example β-cyclodextrin, cellulose acetate, and combinations of bentonite and activated carbon.

One object of the present invention relates to a process for removing Hoffmann analyte smoke precursors from a tobacco extract. Another object of the present invention is directed to a process for removing nitrogen containing compounds from tobacco with minimum removal of desired compounds such as alkaloids that contribute to the flavor of the tobacco and phosphates which have been found to decrease smoke formaldehyde formation. Additionally, proteins are precursors to smoke aromatic and heterocyclic amines and hence are nitrogen containing compounds that are targeted for removal in the present invention.

The process of the present invention generally involves mixing tobacco fines, stems, scraps, cut lamina, shredded stems, or any combination thereof with an aqueous solvent under conditions favoring the extracting of nitrogen containing compounds. The aqueous solvent extract and the tobacco materials are then mechanically separated by centrifuge or by filtration. The tobacco solids or fiber may be left as cut lamina; refined and made into sheets by a paper making process; or refined and digested then mixed with a binder and cast as sheet for band cast sheet processing. In each of the embodied processes for treating the solids, an extract or concentrated extract resulting from a process for treating the aqueous solvent extract is added back to the solids.

The aqueous solvent extract is either passed through an adsorbent packed column or mixed with an adsorbent and mechanically separated by filtration or by centrifuge. The extract is then either mixed with the tobacco solids and cast as sheet via a band cast process or concentrated. The concentrated extract may be added back to the tobacco solids or it may be added back to the tobacco solids after they have been cast into sheets via a paper making process.

The primary objective of the present invention is to reduce the content of nitrogen containing compounds (i.e. proteins, TSNAs, polyphenols (Chlorogenic acid, Ruten, Scopoletin), nitrates and chlorides) in the tobacco while retaining desired constituents that contribute to the flavor (i.e. alkaloids, fructose and glucose) of the tobacco or reduce undesired constituents in the smoke (i.e. phosphates reduce formaldehyde concentration in the smoke).

### DESCRIPTION OF DRAWING

The drawing attached hereto is a flow diagram of a process for treating tobacco in accordance with a preferred embodiment of the present invention.

### DETAILED DESCRIPTION OF THE PREFERRED EMBODIMENTS

The process is best described with reference to the drawing. The first step of the process involves mixing (step 1) tobacco fines, stems, scraps, cut lamina, shredded stems, or any combination thereof. The mixed tobacco solids resulting from step 1 are then contacted at step 2 with an aqueous solvent under conditions favoring the selective extraction of nitrogen containing compounds. It has been determined that such conditions include adding one part of tobacco with about eleven to about fifteen parts of water and extracting at a temperature of about 160° F. for about 30 minutes. The aqueous solvent extract or weak extract liquor (WEL) formed in step 2 and the solid tobacco materials of step 1 are then mechanically separated at step 3 by either filtration or centrifugation.

The WEL, as indicated at step 4, is either passed through an adsorbent packed column (step 5) or mixed with an adsorbent (step 6) and separated, as indicated at step 7, from the adsorbent. The separation or dewatering at step 7 may be accomplished by filtration, by basket centrifuge, or by stacked disc centrifuge. The adsorbent resulting from step 7 is then discarded, as indicated at step 8. Whether the extract with the water soluble compounds at step 4 is passed through a packed column (step 5) or mixed with an adsorbent (step 6), an extract with reduced nitrogen containing compounds (step 9) is yielded. The extract with reduced nitrogen containing compounds (step 9) is then either mixed (step 13) with the tobacco solids and cast as sheet (step 14) via a band cast process or concentrated (step 10). Concentration (step 10) is accomplished by placing extract from step 9 under a vacuum to evaporate the aqueous solvent and yield a concentrated extract having about 30% to about 35% solids. The concentrated extract from step 10 may be applied directly to the tobacco solids at step 19 or it may be applied to the tobacco solids after they have been cast into sheets at step 17 via a paper making process.

The tobacco solids (step 11) or fiber may be left as cut lamina (step 18); refined (step 15) and made into sheets by a paper making process (step 16); or refined and digested (step 12). Digestion at step 12 may be accomplished by digesting with an alkali (up to 12% dwb) at about 90° C. to about 121° C., up to 30 psig for about 15 to about 120 minutes. The refined and digested solids resulting from step 12 are then mixed at step 13 with a binder and extract from step 9 or concentrated extract from step 10 and cast as sheet from step 14 via band cast sheet processing.

The refined tobacco solids resulting from step 15 are made into sheets via a paper making process (step 16), after which the concentrated extract resulting from step 10 is added back to the tobacco material that is now in the form of a sheet (step 17). Additionally, the tobacco solids from step 11 may be left as cut lamina at step 18 and the concentrated extract resulting from step 10 may be reapplied directly at step 19.

A vital aspect of the present invention is the adsorbent material used in packed column in step 5 or the mixing step 6. It has been determined that mixtures of bentonite clay and activated carbon, β-cyclodextrin, and cellulose acetate produce the desired effect of selectively removing Hoffmann anlaytes from the WEL (step 4) without removing the desired compounds such as alkaloids and phosphates. Cyclodextrins are starched derived cyclic maltooligosaccharides, known to form inclusion complexes with several compounds. Due to the latter property and low water solubility characteristics, cyclodextrins are used to encapsulate flavors, de-bitter fruit juices, and separate cholesterol from egg yolk.

### EXAMPLES 1-4

Experiments were undertaken to evaluate the effectiveness of adsorbents against an untreated control, bentonite and activated carbon. Two different methods of contacting the WEL with the adsorbents were evaluated, packed column technology (PC) and re-circulation (Re). The objective of these experiments was to evaluate adsorbents against bentonite and activated carbon for selective Hoffmann analyte reduction and the retention of selected desired components in weak extract liquor. It has been determined that increased phosphate levels in tobacco blends decrease smoke formaldehyde formation. Proteins are precursors to smoke aromatic and heterocyclic amines. Therefore the percentage of removal of TSNAs, protein, chlorogenic acid, ruten, and scopoletin is reported and the percentage of retention of alkaloids and phosphates is reported.

The adsorbents tested were cellulose acetate, β-cyclodextrin, and several combinations of bentonite and activated carbon. Since it is often difficult to achieve complete mechanical separation of the selected adsorbents from the WEL after mixing with the adsorbents, both packed column and re-circulation processes were tested. The following examples depict the results of analyses run on the WEL after contacting the adsorbents of the present invention as well as several control samples.

### Example 1

Preparation of Weak Extract Liquor:

WEL was prepared by first mixing a blend of flue-cured and burley scrap in a ratio of about 1 to 1. This tobacco blend was then extracted once with water for about 15 to about 30 minutes at about 60° C. to about 90° C. The tobacco solids were then dewatered by centrifugation. The liquids or WEL side was retained while the tobacco solids side was discarded.

Packed Column Preparation (PC):

Laboratory size glass columns were separately hand packed with about 25 g to about 50 g of cellulose acetate, activated carbon and β-cyclodextrin. Approximately 600 ml. of the WEL was then passed through each column at an elution rate of about 20 ml. per minute. The eluted extracts were subsequently submitted for analysis.

TABLE I
Burley weak extract treatment with adsorbents in a Packed Column

| | Soluble | Nitrate | | TSNAs | Polyphenols | | | | |
|---|---|---|---|---|---|---|---|---|---|
| Sample | Protein | mg/ml | Chloride | ppm | mg/ml (% rem.) | | | Alkaloid | Phosphates |
| Description/ | mg/ml | (% | mg/ml | (% | Chlorogenic | | | mg/ml | mg/ml (% |
| Adsorbent | (% rem.) | rem.) | (% rem.) | rem.) | acid | Ruten | Scopoletin | (% ret.) | ret.) |
| Untreated | .47 | 99.49 | 570.05 | .528 | .034 | .027 | >.005 | 1175.7 | 215.22 |
| Cellulose | .29 (38) | 532.42 (47) | 410.72 (28) | .089 (83) | 0.00 (100) | 0.00 (100) | 0.00 (100) | 373.49 (32) | 0.00 (0) |
| Acetate | | | | | | | | | |
| Activated | .26 (45) | 612.76 (39) | 418.50 (27) | .007 (99) | 0.00 (100) | 0.00 (100) | 0.00 (100) | 0.00 (0) | 126.74 (59) |
| Carbon | | | | | | | | | |
| β- | .17 (64) | 620.76 (38) | 319.17 (44) | .212 (60) | 0.00 (100) | 0.00 (100) | >.005 ADL^{a} | 665.64 (57) | 126.3 (59) |
| cyclodextrin | | | | | | | | | |

^{a}Above detection limit

β-cyclodextrin was found to be the most effective adsorbent in removing soluble proteins from the WEL by removing 64%. Additionally, β-cyclodextrin removed 60% of the TSNAs from the WEL while the WEL retained 57% of the alkaloids and 59% of the phosphates. Cellulose acetate was also found to be effective by removing 38% of the soluble proteins and 83% of the TSNAs while retaining 32% of the alkaloids. The activated carbon was found not to be selective in the removal of nitrogen containing compounds by removing 100% of the alkaloids.

### Example 2

Re-circulation (RC):

Separate samples of approximately 9 g of β-cyclodextrin and approximately 9 g of bentonite were placed into separate Erlenmeyer flasks. Approximately 300 ml of the WEL prepared in Example 1 was mixed with each 9 g sample of an adsorbent. The resulting solutions were stirred in the Erlenmeyer flasks for about 15 to about 30 minutes at about 90° F. The mixtures were then separately centrifuged. Each extract was then decanted and submitted for analyses. The residues were then discarded. The following table depicts the results of analyses run on the WEL after contacting the adsorbents of the present invention as well as control samples.

TABLE II
Burley weak extract treatment with adsorbents via Recirculation

| | Soluble | | | TSNAs | Polyphenols | | | | |
|---|---|---|---|---|---|---|---|---|---|
| Sample | Protein | Nitrate | Chloride | ppm | mg/ml (% rem.) | | | Alkaloid | Phosphates |
| Description/ | (mg/ml) | mg/ml | mg/ml | (% | Chlorogenic | | | mg/ml | mg/ml |
| Adsorbent | (% rem.) | (% rem.) | (% rem.) | rem.) | acid | Ruten | Scopoletin | (% ret.) | (% ret.) |
| Untreated | .55 | 1250.07 | 644.91 | .471 | .342 | .025 | >.005 | 1414.26 | 207.07 |
| β- | .41 (25) | 1190.08 (5) | 605.62 (6) | .408 (13) | .040 (18) | .032 (−24) | >.005 (ADL) | 1325.07 (94) | 186.60 (90) |
| cyclodextrin | | | | | | | | | |
| Bentonite | .19 (83) | 1312.02 (−4) | 781.96 (−21) | .388 (18) | 0.00 (100) | 0.00 (100) | >.005 (ADL) | 461.97 (33) | 0.00 (0) |

β-cyclodextrin was found to be effective in the recirculation process as well. β-cyclodextrin removed 25% of the proteins from the WEL while the WEL retained 94% of the alkaloids and 90% of the phosphates. Bentonite was found not to be as selective in removal since the WEL only retained 33% of the alkaloids and none of the phosphates.

### Example 3

Separate samples of bentonite, activated carbon, and a mixture comprising about 1 part of bentonite for each part of activated were placed into separate Erlenmeyer flasks. WEL, as prepared in example 1, was added to the Erlenmeyer flasks containing the activated carbon and bentonite samples to obtain a 0.8% solution. WEL was added to the Erlenmeyer flask containing the mixture of bentonite and activated carbon to obtain a solution having 1% bentonite and 1% activated carbon. The resulting solutions were then stirred in the Erlenmeyer flasks for about 15 to about 30 minutes at about 90° F. The mixtures were then separately centrifuged. Each extract was then decanted and submitted for analyses. The residues were then discarded. The following table depicts the results of analyses run on the WEL after contacting the adsorbents of the present invention as well as control samples.

TABLE III
Burley weak extract treatment with adsorbents via Recirculation

| | | | | | | | Nitrate |
|---|---|---|---|---|---|---|---|
| | Soluble Protein | TSNAs | Polyphenols mg/ml (% rem.) | | | Alkaloid | mg/ml |
| | mg/ml | ppm | Chlorogenic | | | mg/ml | (% |
| Sample Description | (% rem.) | (% rem.) | acid | Ruten | Scopoletin | (% ret.) | ret.) |
| Untreated | 284 | .79 | .156 | .2 | .04 | .6 | .55 |
| Bentonite (.8%) | 105 (63) | .42 (46.8) | 0 (100) | .17 (15) | .02 (100) | .63 (−5) | .59 (−7.3) |
| Activated Carbon | 120 (57.7) | .06 (92.4) | 0 (100) | 0 (100) | 0 (100) | .58 (3.3) | .58 (−5.5) |
| (AC, .8%, pellets) | | | | | | | |
| Bentonite/AC | 43 (85) | .15 (81) | 0 (100) | 0 (100) | 0 (100) | .32 (46.7) | .57 (−3.6) |
| (1%/1%) | | | | | | | |

The bentonite and activated carbon (1:1) adsorbent was found to be more effective in selectively removing the soluble proteins, TSNAs, ruten, and scopoletin without removing a substantial amount of alkaloids. The separate bentonite and activated carbon adsorbents were found not to be selective in the removal of nitrogen containing compounds since they adsorbed almost all of the alkaloids.

### Example 4

A variety of combinations of bentonite and activated carbon were tested in relation to varying amounts of separate samples of bentonite and activated carbon. These tests were performed on two WELs prepared as in example 1, one prepared from burley and the other prepared from flue cured tobacco. The WELs were tested with the adsorbents using the recirculation process in example 2.

TABLE IV
Burley weak extract treatment with adsorbents via Recirculation

| | | Soluble | Polyphenols | | | |
|---|---|---|---|---|---|---|
| | TSNAs^{a} | Protein | mg/ml (% rem.) | | | Alkaloid |
| Sample Description/ | ppm | mg/ml | Chlorogenic | | | mg/ml |
| Adsorbent^{c} | (% rem.) | (% rem.) | acid | Ruten | Scopoletin | (% ret.) |
| Untreated | .92 | 289 | .18 | 0.25 | 0.04 | .75 |
| Burley | | | | | | |
| Bent. (.5%) | .56 (39) | 139 (52) | .10 (44) | 0.11 (56) | 0.01 (75) | .77 (0) |
| Bent. (1%) | .51 (45) | 101 (65) | 0.01 (94) | 0.02 (92) | 0.01 (75) | .71 (95) |
| Bent. (2%) | .54 (41) | 79 (83) | 0.00 (100) | 0.00 (100) | 0.01 (75) | .69 (92) |
| AC (.4%)^{b} | .11 (88) | 170 (41) | 0.00 (100) | 0.00 (100) | 0.00 (100) | .47 (63) |
| AC (.8%)^{b} | .05 (95) | 160 (45) | 0.00 (100) | 0.00 (100) | 0.00 (100) | .39 (52) |
| AC (1%)^{b} | .01 (99) | 160 (45) | 0.00 (100) | 0.00 (100) | 0.00 (100) | .33 (44) |
| AC (2%)^{b} | 0.00 (100) | 140 (52) | 0.00 (100) | 0.00 (100) | 0.00 (100) | 0.00 (0) |
| Bent./AC (1:1) | .09 (90) | 60 (79) | 0.00 (100) | 0.00 (100) | 0.00 (100) | 0.49 (65) |
| Bent./AC (1:2) | .02 (98) | 40 (86) | 0.00 (100) | 0.00 (100) | 0.00 (100) | 0.33 (44) |
| Bent./AC (1:3) | 0.00 (100) | 80 (73) | 0.00 (100) | 0.00 (100) | 0.00 (100) | 0.32 (43) |
| Bent./AC (1:4) | 0.00 (100) | 99 (65) | 0.00 (100) | 0.00 (100) | 0.00 (100) | 0.30 (40) |
| Bent./AC (2:1) | 0.10 (87) | 20 (93) | 0.00 (100) | 0.00 (100) | 0.00 (100) | 0.42 (56) |
| Untreated | 0.52 | 458 | 0.34 | 0.30 | 0.04 | 0.47 |
| Flue-cure | | | | | | |
| Bent./AC | 0.00 (100) | 92 (73) | 0.00 (100) | 0.00 (100) | 0.00 (100) | .31 (66) |
| (1:1) | | | | | | |

^{a}NNK, NNN, NAB, NAT.
^{b}Activated carbon powder (0.4-2.0 parts powder is as effective as 5-8 parts pellets).
^{c}Based on 1.0% (w/v) of adsorbent used.

The adsorbents of the different combinations of bentonite and activated carbon were more effective in removing soluble proteins, TSNAs and polyphenols than the bentonite or activated carbon alone. Additionally, the adsorbents of the different combinations of bentonite and activated carbon were selective in removal of these constituents in that a substantial percentage of the alkaloids remained in the WEL. Additionally, the one to one bentonite and activated carbon adsorbent was found to selectively remove the nitrogen containing compounds without the undesired removal of alkaloids in a WEL made from flue cured tobacco.

1. A process for selectively removing nitrogen containing compounds from tobacco, comprising the steps of:
mixing a first tobacco containing material with an aqueous solvent to form an extract and a first tobacco residue;
separating said first tobacco residue from said extract;
contacting said extract with an adsorbent material, wherein said adsorbent material is selected from the group consisting of a bentonite and activated carbon material, cellulose acetate, β-cyclodextrin and combinations thereof; and
introducing said extract to a second tobacco containing material.

2. The process of claim 1 wherein said mixing of said first tobacco containing material with an aqueous solvent is at about 60° to about 90° C. for about 15 to about 30 minutes.

3. The process of claim 1 wherein said mixing of said first tobacco containing material with an aqueous solvent is carried out with about one part of tobacco to about eleven to fifteen parts of water.

4. The process of claim 1 wherein said separating of said first tobacco residue from said extract is accomplished by centrifuge or by filtration.

5. The process of claim 1 wherein said contacting an extract with an adsorbent material is carried out by passing said extract through a packed column having said adsorbent.

6. The process of claim 1 wherein said contacting an extract with an adsorbent material is accomplished by re-circulating said extract with said adsorbent.

7. The process of claim 6 wherein said extract is separated from said adsorbent material by centrifuge or filtration.

8. The process of claim 1 wherein said adsorbent material has bentonite and activated carbon.

9. The process of claim 8 wherein said adsorbent has about one part of activated carbon for one part of bentonite.

10. The process of claim 8 wherein said adsorbent has about two parts of activated carbon for one part of bentonite.

11. The process of claim 8 wherein said adsorbent has about three parts of activated carbon for one part of bentonite.

12. The process of claim 8 wherein said adsorbent has about four parts of activated carbon for one part of bentonite.

13. The process of claim 8 wherein said adsorbent has about two parts of bentonite for one part of activated carbon.

14. The process of claim 1 wherein said adsorbent material has cellulose acetate.

15. The process of claim 1 wherein said adsorbent material has β-cyclodextrin.

16. The process of claim 1 wherein said process includes a step of concentrating said extract forming a concentrated extract, wherein said concentrating step follows said step of separating said first tobacco containing material from said extract.

17. The process of claim 1 wherein said second tobacco containing material is said first tobacco residue.

18. An adsorbent for selective removal of nitrogen containing compounds from an aqueous tobacco extract, wherein said adsorbent is selected from the group consisting of a bentonite and activated carbon material, cellulose acetate, β-cyclodextrin and combinations thereof.

19. The adsorbent of claim 18 wherein said bentonite and activated carbon material comprises bentonite and activated carbon in a ratio of about one part of bentonite to about one part of activated carbon.

20. The adsorbent of claim 18 wherein said bentonite and activated carbon material comprises bentonite and activated carbon in a ratio of about one part of bentonite to about two parts of activated carbon.

21. The adsorbent of claim 18 wherein said bentonite and activated carbon material comprises bentonite and activated carbon in a ratio of about one part of bentonite to about three parts of activated carbon.

22. The adsorbent of claim 18 wherein said bentonite and activated carbon material comprises bentonite and activated carbon in a ratio of about one part of bentonite to about four parts of activated carbon.

23. The adsorbent of claim 18 wherein said bentonite and activated carbon material comprises bentonite and activated carbon in a ratio of about two parts of bentonite to about one part of activated carbon.
